(19) United States
(12) Patent Application Publication
(10) Pub. No.: US 2006/0280905 A1
(43) Pub. Date: Dec. 14, 2006

(54) Honeycomb structure

(75) Inventor: Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., Nagoya-city (JP)

(21) Appl. No.: 11/450,263

(22) Filed: Jun. 12, 2006

(30) Foreign Application Priority Data
Jun. 14, 2005 (JP) 2005-173562

(51) Int. Cl. B32B 3/12; B21D 39/00

(52) U.S. Cl. 428/116; 428/117; 428/593

(57) ABSTRACT

A honeycomb structure has a plurality of cells which are partitioned by partition walls and function as fluid passages, and an end portion of predetermined cells is plugged by a plugging member. The plugging member has lower rigidity than that of the partition walls and has higher heat capacity than that of the partition walls. The honeycomb structure is excellent in durability because it hardly has a crack or a melting damage in a boundary portion between a partition wall and a plugged portion or an end portion.

### TECHNICAL FIELD OF THE INVENTION

The present invention relates to a honeycomb structure. More specifically, the present invention relates to a honeycomb structure used as a filter for exhaust gas from various kinds of internal combustion engines, a filter for various kinds of filtration instruments, a heat exchanger unit, or a carrier for chemical reaction instruments such as carrier for a reforming catalyst for a fuel cell, or the like.

### DESCRIPTION OF RELATED ART

There has conventionally been used a honeycomb structure having predetermined cells plugged with a plugging member as a filter (e.g., diesel particulate filter: DPF) for trapping and removing particulate matter contained in fluid containing dust such as exhaust gas discharged from a diesel engine. In this case, a honeycomb-structured filter forms a plurality of cell passages constituted by a plurality of porous partition walls in parallel with one another and employs a structure of plugging an end portion (or an intermediate portion) of each cell passage alternately. In addition, in order to regenerate the filter by combusting the trapped particulate matter, an electric heater or a burner is disposed upstream of exhaust gas of the filter.

However, in the case that the trapped particle matter is combusted in a filter, temperature rises most in the vicinity of plugged portion on the end face on outlet side to cause a crack due to thermal shock at an end portion (end face) of the honeycomb structure or a melting damage during an excessive temperature rise.

For such a problem, there has conventionally been employed a method in which a plugged portion of an exhaust gas outlet end portion of the honeycomb structure is thicken in a central portion on the outlet side where temperature particularly rises (see Patent Document 1). By such a method, rigidity against a temperature change in the central portion on the outlet side, and a temperature rise in the central portion on the outlet side is suppressed to inhibit a thermal crack.

As a structure in which plugged portions are made thicker in order from the peripheral portion of the outlet portion toward the central portion, decrease in a partition wall filter area is suppressed as much as possible lest the trapping performance for the particulate matter should be reduced in a great deal. However, in such a structure, increase in heat capacity in the central portion is insufficient, and it is pointed out that the temperature difference is large between the peripheral portion and the central portion (see Patent Document 2). If the negative aspect of decrease in a partition wall filter area is sacrificed to some extent, those skilled in the art would easily hit upon the idea of making the plugged portions thicker on the whole outlet side than those on the inlet side. However, it causes decrease in a partition wall filter area, and therefore, the whole filter function is not well balanced.

Therefore, Patent Document 2 employed a method where the plugged portions in the exhaust gas inlet end portion of the honeycomb structure and in the central portion on the outlet side where temperature particularly rises were made thick. By increasing heat capacity in the inlet side central portion by such a method, temperature rise is suppressed in the inlet side central portion to reduce the temperature difference between the outlet side central portion and the peripheral portion, thereby inhibiting a melting damage or a thermal crack. As these conventional techniques, plugged portions in the outlet portion or on the inlet side are thicken to impart high heat capacity to the end portion.

Recently, partition walls in a honeycomb structure has had a higher porosity and thinned in order to treat exhaust gas more effectively by reducing a pressure loss upon treating exhaust gas by the honeycomb structure. In addition, in order to suppress a temperature rise by combustion upon regenerating a filter, it has been thought of that a catalyst is loaded on the filter, thereby combusting the particulate matter even at relatively low temperature. When the amount of the catalyst to be loaded is increased, pores in the partition walls are clogged. Therefore, both increase in porosity of the partition walls and uniformalization of pore distribution is required.

However, since heat capacity of partition walls has been decreased according to a rise in porosity and thinning of partition walls of a honeycomb structure, temperature rises particularly in the vicinity of plugged portions on the outlet side end face in the case that trapped particulate matter is combusted in the filter, thereby causing a problem of a melting damage during a more excessive temperature rise. In addition, in the case that the filter is disposed in the vicinity (close-coupled) of an engine, exhaust gas has relatively high temperature, and temperature change is severe. Therefore, thermal shock at a filter entrance is intense, which arise a problem of generating a crack in the inlet end face portion.

Further, as the prior art described above, plugged portions is give a thick structure, which naturally enhance rigidity of the plugged portions to inhibit a dimensional change of the partition walls due to a temperature change. This sometimes causes a problem of generating a crack at the interface between the partition walls and the plugged portions. Therefore, the plugged portions have conventionally been given a high porosity to ventilate the plugged portion to reduce a pressure loss in the whole filter and to reduce rigidity of the plugged portion.

However, since particulate matter is trapped and accumulated inside the plugged portions when the plugged portions are ventilated, heat is generated also in the plugged portions upon combustion regeneration, which causes excessively high temperature in an end portion. Even if the plugged portions are not ventilated, the plugged portions have a lowered heat capacity due to the raised porosity of the plugged portions, which also causes excessively high temperature in an end portions.

Patent Document 1: JPU-B-63-32890

Patent Document 2: JPU-B-6-31133

### SUMMARY OF THE INVENTION

The present invention has been made in view of the problems of such prior art and aims to provide a honeycomb structure excellent in durability because it hardly has a crack or a melting damage in a boundary portion between a partition wall and a plugged portion or an end portion.

In order to achieve the above aim, the present invention provides the following honeycomb structure.

[1] A honeycomb structure having a plurality of cells partitioned by partition walls and functioning as fluid passages, an end portion of predetermined cells being plugged by a plugging member,

wherein the plugging member has lower rigidity than that of the partition walls and has higher heat capacity than that of the partition walls.

[2] A honeycomb structure according to [1], wherein a material for the plugging member is aluminum titanate or a compound material thereof, and a material for the partition walls is cordierite or a compound thereof.

[3] A honeycomb structure according to [1], wherein the plugging member has lower thermal conductivity than that of the partition walls.

[4] A honeycomb structure according to [1], wherein the plugging member has a lower thermal expansion coefficient than that of the partition walls.

A honeycomb structure of the present invention is excellent in durability because it hardly has a crack or a melting damage in a boundary portion between a partition wall and a plugged portion or an end portion.

### BRIEF DESCRIPTION OF THE DRAWINGS

FIG. 1 is a schematic view of a soot generator (PM compulsory generation apparatus).

### DESCRIPTION OF PREFERRED EMBODIMENTS

Embodiments of the present invention will hereinbelow be described. However, the present invention is limited to the following embodiments, and it should be understand that a change, an improvement, or the like, in design may suitably be given on the basis of ordinary knowledge of those skilled in the art.

A honeycomb structure according to the present invention has a plurality of cells partitioned by partition walls and functioning as fluid passages, an end portion of predetermined cells is plugged by a plugging member, and the plugging member has lower rigidity than that of the partition walls and has higher heat capacity than that of the partition walls.

Thus, in a honeycomb structure of the present invention, since the plugging member has lower rigidity than that of the partition walls, partial stress concentration on the partition walls is lightened by the strain of the plugged portions caused together with the strain of the partition walls when stress is applied on an end portion of a honeycomb structure, thereby inhibiting the partition walls from having a crack to improve durability.

Incidentally, as a case that stress is applied on an end portion of a honeycomb structure, there are a case that thermal stress due to thermal difference or the like is applied on an end face, a case that holding pressure is applied on an outer peripheral surface of a honeycomb structure upon canning, and the like. In addition, there is a case that thermal stress is caused on an end face by the influence of a temperature distribution in a firing furnace or heat generation by combustion of a pore former or the like in a firing step in a production process. Also, in the case that firing is performed in the state that a honeycomb structure is put so that a longitudinal axial direction should correspond to a horizontal direction, a load of the plugged portions is applied on the partition walls of the honeycomb structure, where stress is sometimes applied on an end portion.

In addition, in a honeycomb structure of the present invention, since heat capacity of plugged portions is made larger than that of partition walls, an excessive temperature rise can be avoided by the presence of plugged portions having large heat capacity to inhibit partition walls from having a crack or a melting damage and to avoid spoiling pressure loss performance with no reduction in filter area in the case of having an excessive temperature rise by which a crack or a melting damage is caused due to a thermal shock in an excessive temperature rise caused particularly in the vicinity of plugged portions on the outlet end face when particulate matter is combusted.

Further, in a honeycomb structure of the present invention, it is preferable that a material for the plugging member is aluminum titanate or a compound material thereof and that a material for the partition walls is cordierite or a compound thereof.

A material for the plugging member used in the present invention preferably contains aluminum titanate as the main component. In more detail, it is preferable that the material contains 60% or more of aluminum titanate as a crystal phase, that the other crystal phases are constituted by at least one selected from the group consisting of rutile, corundum, and mullite, and that the aluminum titanate has 5% or less of a glass phase.

Incidentally, a Young's modulus of aluminum titanate (AT) is about one tenth of that of cordierite. Since a Young's modulus of aluminum titanate decreases according to an increase in an amount of AT crystals, the amount of AT crystals is preferably as high as possible. Further, since a Young's modulus of aluminum titanate decreases according to an increase in average crystal grain diameter of AT, a larger average crystal grain diameter of AT is more preferable. A Young's modulus of aluminum titanate changes depending on an amount of AT crystals, an average crystal grain diameter of AT, and porosity, and it is about 0.1 to 50 GPa. Though an average crystal grain diameter is preferably less than 10 μm, a plugging member has sufficient thickness, and stress is not necessarily laid on heat cycle durability. Therefore, when an AT material is used for the plugging member, an average grain diameter of AT may be 10 μm or more, which is convenient because a Young's modulus of the plugging member can be lowered. From the viewpoint of decrease in compression strength of a material, the average crystal grain size is preferably less than 100 μm.

In addition, specific heat of cordierite is about 500 to 1000 J/kgK, which is almost the same as that of aluminum titanate. Since heat capacity [J/K] is the product of mass [kg] times heat capacity [J/kgK], heat capacity per unit volume [J/m³K] can be expressed by the product of absolute specific gravity (density) [kg/m³] times specific heat [J/kgK].

Incidentally, since aluminum titanate has an absolute specific gravity of about 3.6, while cordierite has an absolute specific gravity of about 2.5, assuming that they have about the same porosity, heat capacity of aluminum titanate is 1.44 times larger than that of cordierite.

Since strength and a Young's modulus tend to decrease when porosity rises, Young's modulus of aluminum titanate increases by making porosity of aluminum titanium smaller than that of cordierite. However, since a Young's modulus of aluminum titanate is so small as one tenth of that of cordierite, even if porosity is reduced, aluminum titanate shows sufficiently small Young's modulus. By making porosity of aluminum titanate than that of cordierite, properties of larger heat capacity and a smaller Young's modulus than those of cordierite can be exhibited.

Further, since a thermal expansion coefficient and thermal conductivity reduce according to increase in amount of AT crystals, a higher amount of AT crystals is more preferable, and it is preferably 60% or more. A thermal expansion coefficient (40 to 800° C.) of aluminum titanate is about −2.0×10⁶/° C. to 4.0×10⁻⁶/° C. Thermal conductivity of aluminum titanate is about 3.0 W/mK or less. Though thermal conductivity of cordierite is about 1.0 W/mK or less, aluminum titanate can have smaller thermal conductivity than cordierite by increasing an amount of AT crystals. In the case of a cordierite honeycomb structure, a thermal expansion coefficient (A axis) of 40 to 800° C. is generally 1.5×10⁻⁶/° C. or less. In the present invention, aluminum titanate of plugged portions may have high thermal expansion than that of cordierite of partition walls because aluminum titanate has a lower Young's modulus than that of cordierite. However, it is preferable to make thermal expansion of aluminum titanate lower than that of cordierite because stress at the interface between partition walls and plugged portions can be reduced more.

Incidentally, since the above properties are susceptible to raw material composition, an amount of impurities, an amount of AT crystals, a crystal grain diameter of AT, firing temperature, and the like, predetermined properties can be obtained by suitably selecting production conditions.

A material for partition walls used in the present invention preferably contains cordierite as the main component by synthetic judgment in consideration of structural strength, thermal shock resistance, and mass productivity. That is, it is an invention made in order to solve the problem that a crack is prone to be caused in partition walls since porosity of partition walls of a honeycomb structure has risen in recent years, and the invention is more effective in being applied to a honeycomb structure having a porosity of 45% or more, which is more prone to have a crack. In addition, a honeycomb structure of the present invention can suitably be used in the case that the partition walls have a thickness of 600 μm or less. When the partition wall thickness is small, a crack is prone to be caused in partition walls. Therefore, the present invention is more effective in being applied to a honeycomb structure having a partition wall thickness of 600 μm or less, which is more prone to have a crack.

This is because it is difficult to secure structural strength sufficient for withstanding upon canning because aluminum titanate has very low rigidity (Young's modulus) and strength in comparison with cordierite, silicon nitride, silicon carbide, and the like, though one having partition walls containing aluminum titanate as the main component, which is shown in prior art. Since a Young's modulus is particularly small, buckling stress in the honeycomb structure is remarkably lowered. In recent years, since it is required to make partition walls thin and to rise porosity of partition walls upon reducing a pressure loss and improving catalyst loading ability, difficulty in securing structural strength increases.

Though there is one having partition walls containing silicon nitride or silicon carbide as the main component in prior art, there clearly arises a problem of a thermal crack because of a high thermal expansion coefficient. Because of this, it requires stress release by a segmental structure, and therefore a structure becomes complex to cause an increase in cost. Further, since silicon nitride and silicon carbide are non-oxide, atmosphere firing is required, which is not preferable from the view point of production if mass production is considered.

Here, a honeycomb structure of the present invention has an effect of storing heat generated upon combusting particulate matter in plugged portion by allowing the plugging member to have lower thermal conductivity than that of partition walls. This is effective in suppressing a thermal crack by mitigating a temperature change in an end portion of a honeycomb structure. Since a honeycomb structure, which functions as a filter, is heated up upon cold start of the engine, contribution to early activation of the catalyst can be expected.

Therefore, in a honeycomb structure of the present invention, it is preferable that the plugging member contains aluminum titanate. It is further preferable that the plugging member contains a substance having high heat capacity and low thermal conductivity to enhance effect. It is particularly preferable that the substance having high heat capacity and low thermal conductivity is dispersed in the plugging member in the state of particles. The above substance having high heat capacity and low thermal conductivity is not particularly limited, and, for example, zirconia or tungsten carbide can suitably be used. By dispersing zirconia particles in the plugging member, a heat storing effect can be enhanced.

In addition, in a honeycomb structure of the present invention, partition walls are inhibited from having a crack due to a difference in thermal expansion between the plugged portion and the partition walls because of a heat storing effect of the plugged portion by allowing the plugging member to have a lower thermal expansion coefficient than that of the partition walls even if temperature rises. It is suitable that a thermal expansion coefficient of the plugging member is lower than that of the partition walls in both the direction of cell passages and the direction of a cross-section perpendicular to the cell passages.

If rigidity of the plugging member is sufficiently low, plugged portions can follow the deformation of partition walls even if a thermal expansion coefficient of the plugging member is higher than that of the partition walls. Therefore, it is not necessary to allow the plugging member to have a lower thermal expansion coefficient than that of the partition walls. However, it is preferable that the plugging member has a lower thermal expansion coefficient than that of the partition walls.

Further, in a honeycomb structure of the present invention, heat transfer from the partition walls to the plugged portions can be made smooth by employing a material having high thermal conductivity at the interfaces between the plugging member and the partition walls. The material having high thermal conductivity at the interfaces is not particularly limited as long as it has higher thermal conductivity than the plugging member. It is preferable that the material has heat resistance. In the case that the main component of the plugging member is aluminum titanate, a material such as alumina, silicon nitride, or silicon carbide may suitably used as the material having high thermal conductivity used at the interfaces.

Incidentally, there is no particular limitation on a shape of a honeycomb structure of the present invention, and examples of a shape of a cross-section (a shape of a bottom face) perpendicular to the central axis of a columnar structure of the honeycomb structure include a polygon such as a rectangle, a circle, an oval, an ellipse, and a special shape. Also, there is no particular limitation on a cross-sectional shape of cells, and examples of the shape include a triangle, a rectangle, a hexagon, an octagon, a circle, and a combination thereof. Though the plugged portions are formed generally in a checkerwise pattern, there is no limitation on a pattern of plugging. For example, there may be employed a structure in which a plurality of plugged cell passages are collected, while a plurality of unplugged cell passages are also collected. There may also be employed a structure in which plugged cell passages are collected in a row, while unplugged cell passages are also collected in a row. Alternatively, there may be employed a pattern of concentric circles or a radial pattern. Thus, various patterns may be employed depending on a cell shape. Though a rectangular cell shape is shown in the drawing, there may be employed a polygonal cell such as a triangular cell, or a hexagonal cell; a circular cell; or a combination thereof. Incidentally, all the passage holes do not have to have the same opening area, and passage holes having different opening areas may be present together. Since temperature rises particularly in the vicinity of plugged portions on the exhaust gas outlet side of a filter, it is preferable to make heat capacity of the plugged portions higher on the exhaust gas outlet side than on the exhaust gas inlet side. As a means to raise heat capacity of the plugged portions, there is a measure of increasing capacity of the plugged portions besides increasing heat capacity of a material for the plugged portions. For example, by a structure of plugging rectangular cells on the inlet side and octagonal cells on the outlet side in the combination of octagonal cells and rectangular cells, capacity of the plugged portions on the outlet side becomes larger than that of the plugged portions on the inlet side. In addition, a similar effect can be expected by plugging cells which are not plugged essentially to form plugged portions excessively.

A cell density of the cells formed by the partition walls is not particularly limited. However, if the cell density is too low, strength and effective GSA (geometrical surface area) as a filter are in short. If the cell density is too high, a pressure loss is increased when targeted fluid flows. The cell density is preferably 6 to 2000 cells/inch² (0.9 to 311 cells/cm²), more preferably 50 to 1000 cells/inch² (7.8 to 155 cells/cm²), and most preferably 100 to 600 cells/inch² (15.5 to 93.0 cells/cm²).

Though thickness, that is, length (depth), of the plugged portions in the longer axial direction of the honeycomb structure is not particularly limited, it is preferably 1 to 20 mm. When it is shorter than 1 mm, strength of the plugged member is remarkably lowered, and heat capacity is decreased. When it is longer than 20 mm, a pressure loss as a filter increases. However, in the case of forming the aforementioned excessive plugged portions, they may be longer than 20 mm. Porosity of the plugged portions are not particularly limited. However, when porosity is excessively high, heat capacity is decreased. Therefore, the upper limit of porosity is suitably determined in consideration of heat capacity, and it is practically about 70%. When porosity is excessively low, rigidity is high. Therefore, the lower limit of porosity is suitably determined in consideration of rigidity, and it is practically about 5%. An AT material is originally a material having low rigidity, and rigidity can be adjusted by controlling an average crystal grain diameter. Therefore, the porosity may be less than 5%.

Next, a method for manufacturing a honeycomb structure of the present invention will hereinbelow be described.

As the main raw material of a forming material for forming a honeycomb formed body, it is preferable to use a composition of 0 to 20% by mass of kaolin (Al₂O₃.2SiO₂.2H₂O) having a mean particle size of 5 to 30 μm, 37 to 40% by mass of talc (3MgO.4SiO₂.H₂O) having a mean particle size of 15 to 30 μm, 15 to 45% by mass of aluminum hydroxide having a mean particle size of 1 to 30 μm, 0 to 15% by mass of aluminum oxide having a mean particle size of 1 to 30 μm, and 10 to 20% by mass of fused silica or quartz having a mean particle size of 3 to 100 μm as a raw material for cordierite ceramic excellent in heat resistance and low thermal expansion. In the present invention, a predetermined additive may be added to the ceramic material as necessary. Examples of the additive include a binder, a dispersant for accelerating dispersion in medium liquid, and a pore former for forming pores. Examples of the binder include hydroxypropylmethyl cellulose, methyl cellulose, hydroxyethyl cellulose, carboxylmethyl cellulose, poly(vinyl alcohol), and poly(ethylene terephthalate). Example of the dispersant include ethylene glycol, dextrin, fatty acid soap, and polyalcohol. Examples of the pore former include graphite, coke, flour, starch, foaming resin, water-absorbing resin, phenol resin, poly(ethylene terephthalate), fly ash balloon, silica gel, organic fiber, inorganic fiber, and hollow fiber. These additives may be used alone or in combination of two or more kinds according to the aim.

The ceramic material is generally made to be a mixture having plasticity by adding 10 to 40 parts by weight of water to 100 parts by weight of a mixed raw material powder containing the above main raw material and additives added to the main raw material as necessary and kneading the mixture. Extrusion forming can be conducted by the use of a vacuum kneader, a ram extrusion forming machine, a biaxial screw type continuous extrusion forming machine, or the like. Examples of the external shape of the honeycomb formed body include a column having a shape of an end face of a right circle, or an ellipse; a prism having a shape of an end face of a triangle, or a rectangle; and a shape in which a side of the column or a prism is bent as a dogleg. Though the honeycomb formed body obtained in such a manner can be dried in various methods, it is preferable to employ a method in combination of microwave drying and hot air drying, or a method in combination of dielectric drying and hot air drying. Besides, there may be employed a special method such as freeze drying, drying under reduced pressure, vacuum drying, or far-infrared drying. There is no particular limitation on a drying method of a formed body after extrusion forming, and examples of the drying method includes hot air drying, microwave drying, dielectric drying, drying under reduced pressure, vacuum drying, and freeze drying. Of these, it is preferable to employ dielectric drying, microwave drying, or hot air drying alone or in combination thereof. In addition, as drying conditions, it is preferable to dry at 30 to 150° C. for one to two hours. Then, the dried honeycomb formed body is cut at both end faces to give a predetermined length.

A raw material for the plugging member can be obtained by mixing a surfactant, water, a sintering auxiliary, and the like, with a ceramic raw material to give a mixture, adding to the mixture a pore former as necessary to raise porosity to give a slurry, and kneading the slurry using a mixer, or the like. The material for the plugging member preferably contains aluminum titanate as the main component. It is preferable that 60% or more of aluminum titanate is contained as a crystal phase, and the other crystal phase is constituted as at least one of rutile, corundum, and mullite. It is preferable that the aluminum titanate has a glass phase is 5% or less. The crystal grain has an average particle diameter of less than 10 μm from the viewpoint of heat cycle durability. However, the plugging member has more sufficient thickness than that of partition walls, and stress is not necessarily laid on heat cycle durability. Therefore, when an AT material is used for the plugging member, an average crystal grain diameter of AT may be 10 μm or more.

Examples of the raw material for the plugging member include a-alumina, calcined bauxite, aluminum sulfate, aluminum chloride, aluminum hydroxide, rutile, anatase-type titanium, ilmenite, electromelting magnesium, magnesite, electromelting spinel, kaolin, silica glass, quartz, and electromelting silica. It is preferable that a raw material contains 0.1% by mass or less of each of MgO, CaO, Na₂O, and K₂O, and 1.0% by mass or less of Fe₂O₃.

Besides the ceramic raw material, there can be used a surfactant, water, methyl cellulose, hydroxypropoxyl methyl cellulose, polyethylene oxide, hydroxypropylmethyl cellulose, hydroxyethyl cellulose, carboxylmethyl cellulose, and poly(vinyl alcohol). There is no particular limitation on kind of the surfactant, and examples of the surfactant include ethylene glycol, dextrin, fatty acid soap, and polyalcohol.

In order to enhance porosity, a pore former is added as necessary. There is no limitation on kind of the pore former, and examples of the pore former include graphite, coke, flour, starch, phenol resin, poly(methyl methacrylate), polyethylene, poly(ethylene terephthalate), foaming resin, water-absorbing resin, shirasu balloon, fly ash balloon, silica gel, and alumina gel. A hollow foaming resin having little heat generation upon degreasing and fly ash balloon are preferable. By changing kinds or an amount to be added of such a pore former, porosity and a Young's modulus of the plugging member can be controlled. The amount of pore former to be added is preferably 0.1 to 20 parts by mass with respect to 100 parts by mass of a ceramic raw material used for a raw material of the plugging member.

Next, a part of cells are masked on one end face of the ceramic formed body having a honeycomb structure (one end face of the honeycomb structure). The end face is immersed in the above plugging member stored in a container to allow the plugging member to enter the cells with no mask. Thus, the plugged portions are formed. Cells without a mask on the end face described above (remaining cells) are masked on the other cells of the honeycomb structure. The end face is immersed in the above plugging member stored in a container to allow the plugging member to enter the cells with no mask. Thus, the plugged portions are formed. At this time, cells having plugged portions and cells without plugged portions are alternatively present on both the end faces to form a checkerwise pattern.

A method for masking is not particularly limited, and there may be employed, for example, a method in which an adhesive film is applied on the whole end face of the honeycomb structure, followed by partially making holes in the adhesive film. To be more concrete, there can suitably be used a method of making holes by laser only in the portions corresponding to cells where the plugging portions are formed after the adhesive film is applied on the whole end face of the honeycomb structure. As the adhesive film, there may suitably be used one made of polyester, polyethylene, or a resin such as a heat curing resin with an adhesive is applied on one surface thereof.

The above ceramic formed body having a honeycomb structure having both ends plugged in a checkerwise pattern is dried at 40 to 250° C. for 2 minutes to 2 hours. After the drying, it is fired at 1350 to 1450° C. for 1 to 20 hours in an ambient atmosphere to manufacture a honeycomb structure of the present embodiment plugged with the plugging member. There may be employed a method where a honeycomb structured formed body is once fired, plugging is conducted to the honeycomb structured fired body, and firing is conducted to the plugged portions.

When a Young's modulus of the plugging member of the honeycomb structure is higher than that of the partition walls upon the firing described above, a strain on the partition walls is not lightened, and partial stress concentration is caused in the partition walls, which sometimes generates a crack in a partition wall, in the case that thermal stress due to a temperature difference or the like upon firing is caused at an end face of the honeycomb structure. Therefore, by controlling a Young's modulus of the plugging member to be lower than that of the partition walls, an effect of suppressing a crack upon firing is exhibited.

Also, when an expansion or shrinkage rate of the plugging member is smaller than that of the partition walls upon firing, stress due to the difference in expansion or shrinkage rate is generated on an end face of the honeycomb structure, and a partial stress concentration is caused in the partition walls, which sometimes generates a crack in a partition wall. Therefore, a Young's modulus of the plugging member should be lower than that of the partition walls. Here, an expansion or shrinkage ratio is a value for expressing expansion and shrinkage before and after firing and can be obtained from “(length before firing)/(length after firing).

### EXAMPLE

The present invention is hereinbelow described more concretely with referring to Examples. However, the present invention is by no means limited to these Examples.

### Example 1

There was manufactured a DPF (honeycomb structure) which is a cordierite honeycomb structure (porosity of partition walls: 73%, mean pore diameter: 14 μm) having a partition wall thickness of 310 μm, a cell density of 46.5 cells/cm² (300 cells/inch²), a diameter of 144 mm, and a length of 152 mm and is formed unitarily with an outer wall of about 1 mm, and which has plugged portions having a length of 3 mm and was plugged with a plugging member containing aluminum titanium as the main component (content of aluminum titanate: 90% by mass) on both of the end faces of the honeycomb structure to give a checkerwise pattern.

### Example 2

There was manufactured a DPF (honeycomb structure) which is an outer wall coating type cordierite honeycomb structure (porosity of partition walls: 66%, mean pore diameter: 21 μm) having a partition wall thickness of 310 μm, a cell density of 46.5 cells/cm² (300 cells/inch²), a diameter of 267 mm, and a length of 305 mm and is subjected to machining in the peripheral portion of the honeycomb structure, followed by applying a new outer wall, and has plugged portions having a length of 6 mm and was plugged with a plugging member containing aluminum titanium as the main component (content of aluminum titanate: 90% by mass) on both of the end faces of the honeycomb structure to give a checkerwise pattern.

### Comparative Example 1

There was manufactured a DPF (honeycomb structure) which is a cordierite honeycomb structure (porosity of partition walls: 73%, mean pore diameter: 14 μm) having a partition wall thickness of 310 μm, a cell density of 46.5 cells/cm² (300 cells/inch²), a diameter of 144 mm, and a length of 152 mm and is formed unitarily with an outer wall of about 1 mm, and which has plugged portions having a length of 3 mm and was plugged with a cordierite plugging member having a porosity of 77% on both of the end faces of the honeycomb structure to give a checkerwise pattern.

### Comparative Example 2

There was manufactured a DPF (honeycomb structure) which is an outer wall coating type cordierite honeycomb structure (porosity of partition walls: 66%, mean pore diameter: 21 μm) having a partition wall thickness of 310 μm, a cell density of 46.5 cells/cm² (300 cells/inch²), a diameter of 267 mm, and a length of 305 mm and is subjected to machining in the peripheral portion of the honeycomb structure, followed by applying a new outer wall, and has plugged portions having a length of 6 mm and was plugged with a cordierite plugging member having a porosity of 77% on both of the end faces of the honeycomb structure to give a checkerwise pattern.

Incidentally, porosity of the partition walls of each of the honeycomb structures was measured by a mercury porosimetry, and porosity of the plugged portions was measured by an Archimedes method.

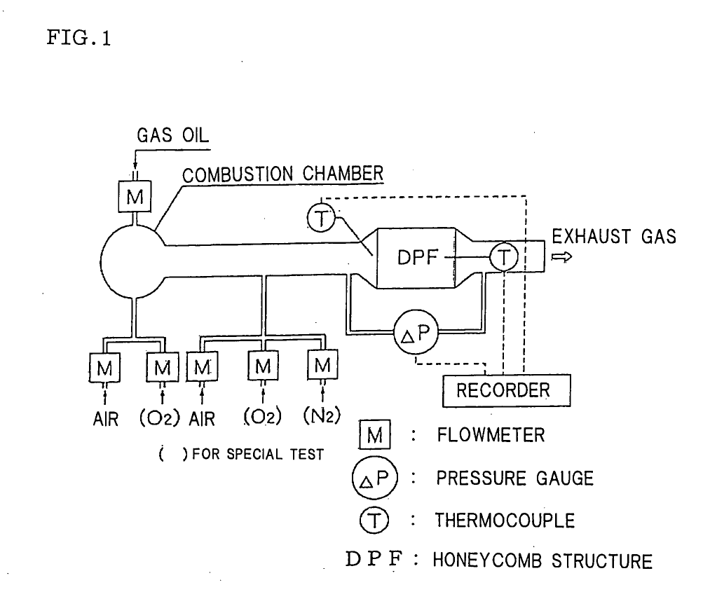

Next, each of the DPFs manufactured above (honeycomb structures) was disposed in a soot generator, which generate particulate matter by a burner using gas oil as the fuel, as shown in FIG. 1. Exhaust gas at about 200° C. from the burner is introduced into the DPF (honeycomb structure) to increase the amount of soot accumulated until 5 to 15 g/L per unit volume of the honeycomb structure in order. Then, exhaust gas at 650 to 700° C. is introduced into a DPF (honeycomb structure) to combust the accumulated soot for a compulsory regeneration test. The results are shown in Table 1. Incidentally, the amount of exhaust gas was adjusted in accordance with the volume of the DPF (honeycomb structure). In addition, standard conditions of the exhaust gas were as follows:

(1) Upon Trapping PM

Temperature: 200° C.
Flow rate: 9 Nm³/min
PM amount: 90 g/hr
   (2) Upon Regeneration
Temperature: 600 to 700° C.
Flow rate: 1.5 Nm³/min

In addition, each of the DPFs (honeycomb structures) manufactured above was disposed in a burner using LPG as the fuel, and 20 cycles of rapid heating and rapid quenching between 100 to 650° C. was carried out. The results are shown in Table 1. Incidentally, the exhaust gas amount was adjusted in accordance with the volume of the DPF (honeycomb structure).

TABLE 1

| | | Rapid heating/ |
|---|---|---|
| | Compulsory | rapid quenching |
| | regeneration test | cycle test |
| Example 1 | Good (no melting damage) | Good (no crack) |
| Example 2 | Good (no melting damage) | Good (no crack) |
| Comp. Ex. 1 | Bad (having melting damage) | Bad (having crack) |
| Comp. Ex. 1 | Bad (having melting damage) | Bad (having crack) |

### Study: Examples 1 and 2, Comparative Examples 1 and 2

As a result of Table 1, each of Comparative Examples 1 and 2 had a melting damage in a part of partition walls in the vicinity of plugged portions on the outlet side of the honeycomb structure, while each of the Examples 1 and 2 had no melting damage. In addition from the results of Table 2, in each of Comparative Examples 1 and 2, a crack was caused in a part of partition walls in the vicinity of plugging portions on the inlet side of the honeycomb structure, while each of the Examples 1 and 2 had no crack generated.

A honeycomb structure of the present invention can suitably be used as a filter for exhaust gas from various kinds of internal combustion engines, a filter for various kinds of filtration instruments, a heat exchanger unit, or a carrier for chemical reaction instruments such as carrier for a reforming catalyst for a fuel cell, or the like.

What is claimed is:

1. A honeycomb structure comprising a plurality of cells partitioned by partition walls and functioning as fluid passages, an end portion of predetermined cells being plugged by a plugging member,
wherein the plugging member has lower rigidity than that of the partition walls and has higher heat capacity than that of the partition walls.

2. A honeycomb structure according to claim 1, wherein a material for the plugging member is aluminum titanate or a compound material thereof, and a material for the partition walls is cordierite or a compound thereof.

3. A honeycomb structure according to claim 1, wherein the plugging member has lower thermal conductivity than that of the partition walls.

4. A honeycomb structure according to claim 1, wherein the plugging member has a lower thermal expansion coefficient than that of the partition walls.
